(19) United States
(12) Patent Application Publication
(10) Pub. No.: US 2006/0041344 A1
(43) Pub. Date: Feb. 23, 2006

(54) Monitoring apparatus and method for handling detected results of a monitored object

(75) Inventor: Tomotake Ooba, Tsuruoka-Shi (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KAWASAKI-SHI (JP)

(21) Appl. No.: 11/148,225

(22) Filed: Jun. 9, 2005

(30) Foreign Application Priority Data
Jun. 18, 2004 (JP) 2004-180482

(51) Int. Cl. G06F 19/00

(52) U.S. Cl. 701/29; 340/442

(57) ABSTRACT

A control device according one embodiment of the invention includes a detection section detecting a physical state of an object to be detected, a measurement section measuring a physical quantity of an object to be measured, a first control section controlling the measurement section to measure the physical quantity periodically, and a second control section controlling the detection section to detect the physical state of the object to be detected before the first control section starts operating. The first control section outputs a measurement result of the measurement section according to a detection result of the detection section.

### BACKGROUND OF THE INVENTION

1. Field of the Invention

The present invention relates to a monitoring apparatus, more particularly monitoring apparatus which processes a state detection result of a monitored object according to a motion detection result.

2. Description of Related Art

Recently, safety regulations are enhanced in both Japan and the United States. Transportation Recall Enhancement, Accountability and Documentation (TREAD) Act enforced in North America establishes a new standard that requires the installation of a tire pressure monitoring system (TPMS) The standard applies to new vehicles marketed after 2006.

There are currently two types of TPMS: indirect measurement systems and direct measurement systems.

The indirect measurement systems monitor the tire pressure by detecting a decrease in air pressure from a difference in the rotational speed of the left and right wheels with a wheel speed sensor used in Anti Lock Brake System (ABS). The systems require substantially no additional cost as long as ABS is installed. However, the systems have drawbacks that air pressure measurement accuracy is lower than direct measurement systems, air pressure is not detectable if air pressure decrease happens in all four tires, and a measurement error occurs when a tire size is changed, and so on. Therefore, not a few consumers' groups in the U.S. are anxious about monitoring with the indirect measurement systems.

On the other hand, the direct measurement systems measure an air pressure and temperature with a sensor placed in each tire. This system installs a sensor unit in a valve of a tire and monitors all four tires individually. This system therefore has a high monitoring accuracy and allows monitoring of the tire pressure even during parking or stopping. Being more accurate than the indirect systems, the direct systems are expected to prevail over time.

One of the direct measurement systems is a system that measures the tire pressure at regular time intervals, wirelessly transmits the information to a vehicle, and displays the information for a driver. This system is composed of a transmitter module installed in a tire wheel and a receiver module installed in a vehicle body. The transmitter module includes a plurality of kinds of sensors for detecting pressure, temperature, and so on. The sensors and so on are semiconductor devices and require power supply. A battery is generally used batteries is therefore difficult and thus performed when replacing or discarding a tire. For this reason, improvement in battery life is demanded in tire pressure monitor control systems and monitoring methods.

In order to increase battery life of a transmitter module installed in a tire, Japanese Unexamined Patent Publication No. 2003-237327 discloses a transmitter module which operates intermittently to reduce an operation time for lower power consumption.

Since conventional tire pressure monitor control devices cannot replace batteries easily, improvement in battery life and reduction in power consumption are critical.

### SUMMARY OF THE INVENTION

According to one aspect of the present invention, there is provided a monitoring apparatus for monitoring a monitored object comprising a motion sensor detecting motion of an object, a sensor detecting state of an object, and a controlling circuit with intermittent operation, performing an operation for a detection result of the sensor during a normal operation duration, the operation determined based on a detection result of the motion sensor detected before the normal operation duration.

According to another aspect of the present invention, there is provided a monitoring apparatus comprising, a motion sensor detecting motion of a vehicle, a sensor detecting state of a tier of the vehicle, and a controlling circuit repeating a normal operation duration and a power save duration alternately, in a normal operation duration, performing an operation for a detection result of the sensor based on a detection result of the motion sensor detected before the normal operation duration.

According to another aspect of the present invention, there is provided a method for handling a detected result of the monitored object in a monitoring apparatus comprising detecting motion of an object, detecting state of an object, storing a detection result of the motion, activating a controlling circuit in a power save mode for an operation of a detection result of the state, the controlling circuit changing the operation for the detection result of the state based on the detection result of the motion stored before the activation, and turning the controlling circuit into the power save mode after the operation.

The controlling circuit determines the operation for the state detection result based on the motion detection result detected before the normal operation duration, resulting in the reduced operation time of the controlling circuit in the normal operation duration.

### BRIEF DESCRIPTION OF THE DRAWINGS

The above and other objects, advantages and features of the present invention will be more apparent from the following description taken in conjunction with the accompanying drawings, in which:

FIG. 1 is a diagram showing the configuration of a tire pressure monitor control device according to the present invention;

FIG. 2 is a detailed block diagram of a latch;

FIG. 3 is a view showing input and output signals of a latch; and

FIG. 4 is a time chart describing the operation of a tire pressure monitor control device according to the present invention.

### DESCRIPTION OF THE PREFERRED EMBODIMENTS

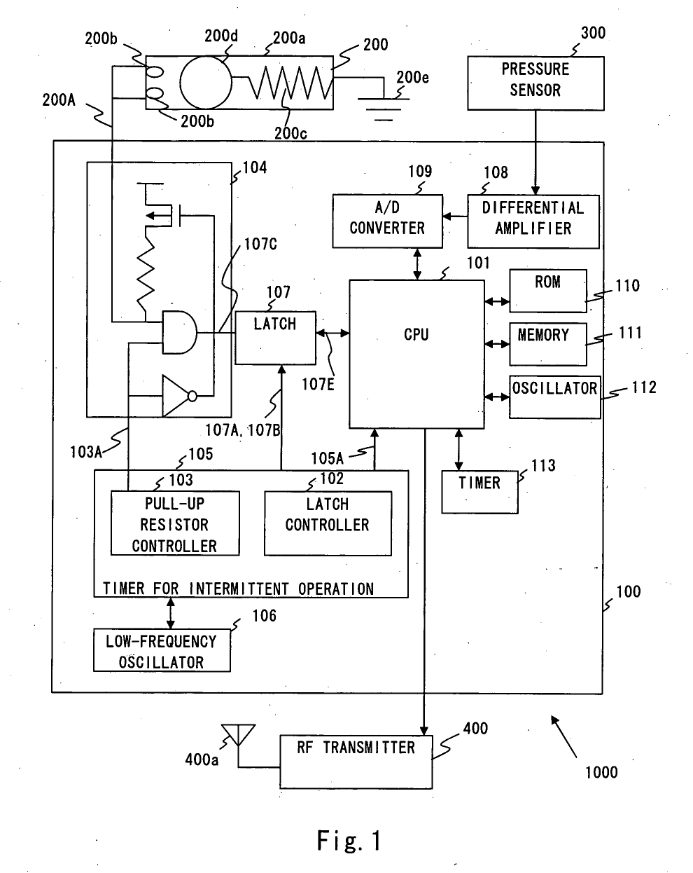

A preferred embodiment of the present invention is described hereinafter with reference to the drawings. FIG. 1 is a diagram showing the configuration of the tire pressure monitor control device according to the present invention. Referring to FIG. 1, a tire pressure monitor control device 1000 comprises a micro computer chip 100 (referred to as computer 100 hereafter), a motion sensor 200, a pressure sensor 300, and an RF transmitter 400. The tire pressure monitor control device 1000 is fixed to a vehicle tire and transmits tire pressure data to a receiver which is placed in a dashboard of a vehicle, not shown, for example. The computer 100 is formed of a semiconductor chip.

The motion sensor 200 detects a physical state of a vehicle as either in drive state or stop state. The motion sensor 200, for example, includes two electrodes 200b at one end inside a thin-walled cylindrical tube 200a and a movable terminal 200d in the longitudinal direction of the tube 200a. The terminal 200d is fixed a spring 200c fixed at the other end of the tube 200a and applied force against the motion in the longitudinal direction of the tube 200a. The spring 200c is connected to a ground 200e. The terminal 200d does not touch the two electrodes 200b during halts while it touches them with centrifugal force of the rotating vehicle tire (driving state) so that the electrodes 200b are connected to the ground 200e to provide High level signal to a motion sensor input circuit 104, which is described later.

The pressure sensor 300 detects and measures pressure of a vehicle tire. A CPU 101 controls the pressure sensor 300 to measure the tire pressure periodically while controlling the entire computer 100. The CPU 101 outputs a measurement result of the pressure sensor 300 to the RF transmitter 400 based on a detection result of the motion sensor 200. Specifically, the CPU 101 outputs the tire pressure data measurement result of the pressure sensor 300 retained in a memory 111, which is described later, to the RF transmitter 400 when the detection result(s) of the motion sensor 200 retained in a latch 107, which is also described later, indicates the vehicle (tire) is moving, namely drive state. On the other hand, when the detection result(s) of the motion sensor 200 retained in the latch 107 indicates the vehicle (tire) is stationary, namely stop state, the CPU 101 does not output the tire pressure data measurement result of the pressure sensor 300 retained in the memory 111 to the RF transmitter 400.

The CPU 101 has a plurality of operation modes, one is a normal operation mode and another is a power save mode for reduction in the power consumption. The CPU 101 may have more different power save modes. The CPU 101 repeats the normal operation duration and the power save duration, and performs operation for the measurement result during the normal operation duration.

A latch controller 102 controls the operation of the latch 107 to take in and temporarily hold the detection result(s) of the motion sensor 200 at predetermined timings so that the data retained in the latch 107 indicate the physical state of the vehicle as either drive or stop state, for example. Specifically, the latch 107 takes in the measurement result(s) predetermined time before the CPU 101 starts operating in the normal operation mode. The latch 107 is composed of a plurality of flip-flops, for example.

A pull-up resistor controller 103 outputs a pull-up control signal periodically to the motion sensor input circuit 104. A timer for intermittent operation 105 includes the latch controller 102 and the pull-up resistor controller 103 and controls their operation timings according to a reference pulse of a low-frequency oscillator 106, as well as the intermittent operation of the CPU 101.

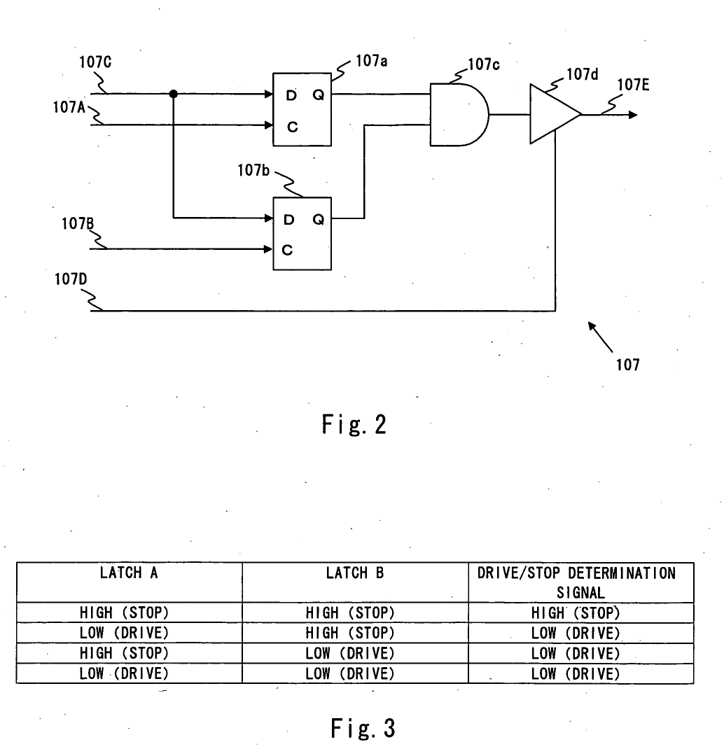

FIG. 2 is a detailed block diagram of the latch 107. Referring to FIG. 2, the latch 107 is composed of two flip-flops as a latch A 107a and a latch B 107b, a logical AND 107c, and an inverter 107d.

A latch A control signal 107A and a latch B control signal 107B are respectively input to the latch A 107a and the latch B 107b from the timer for intermittent operation 105 . . . A port output signal 107C is output from the motion sensor input circuit 104 to the latch A 107a and the latch B 107b. A CPU-SW information reading signal 107D indicates the start-up of the CPU 101 and it is an enable signal from the CPU 101 to the inverter 107d to control the output of the inverter.

The latch 107 outputs signals as shown in FIG. 3 according to the latch A control signal 107A and the latch B control signal 107B. FIG. 3 is a view showing input and output signals of the latch. Referring to FIGS. 2 and 3, before the CPU 101 starts operating (going into the normal operation duration (mode) from the power save duration (mode)), the latch 107 operates by the control of the latch controller 102, receiving a pull-up resistor control signal output from the pull-up resistor controller 103.

The latch 107 takes in and holds the detection results of the motion sensor 200 two times with shifted input timings of the latch A control signal 107A and the latch B control signal 107B by a certain period of time. The latch 107 gets the logical product of outputs of the latch A 107a and the latch B 107b with the logical AND 107c. The vehicle drive/stop information for two times is retained in the latch A 107a and the latch B. Only when the result show stop state (High) at the both timings, it determines that the vehicle is at rest (High) and outputs a drive/stop determination signal 107E to the CPU 101.

It checks the state more than once with a plurality of latch control signals in order to prevent the misdetection of the vehicle (or tire) motion due to the chattering in which the terminal 200d repeatedly touches and non-touches the electrodes 200b, which often occurs during low-speed driving. When a vehicle drives at a low speed, since the detection result of the motion sensor 200 is unstable, detection is performed a plurality of times so as to determine whether the vehicle is driving or at rest from a plurality of detection results. The latch 107 may further include another latch in addition to the latch A 107a and the latch B 107b. The criteria for determining drive state or stop state may be changed as the circuit configuration is altered.

Referring back to FIG. 1, a differential amplifier 108 amplifies a voltage input by the pressure sensor 300. An A/D converter 109 converts the voltage amplified in the differential amplifier 108 from analog to digital. A ROM 110 is used for temporarily storing data. The memory 111 as a storage section stores measurement results from the pressure sensor 300. The CPU 101 operates according to a reference signal from an oscillator 112 and periodically operates intermittently by an output signal 105A of a timer for intermittent operation from the timer for intermittent operation 105.

The RF transmitter 400 has an antenna 400a and transmits data to an external receiver through the antenna 400a. The external receiver is placed in a dashboard of a vehicle body, for example.

The operation of the tire pressure monitor control device according to the present invention is described hereinafter with reference to the drawings.

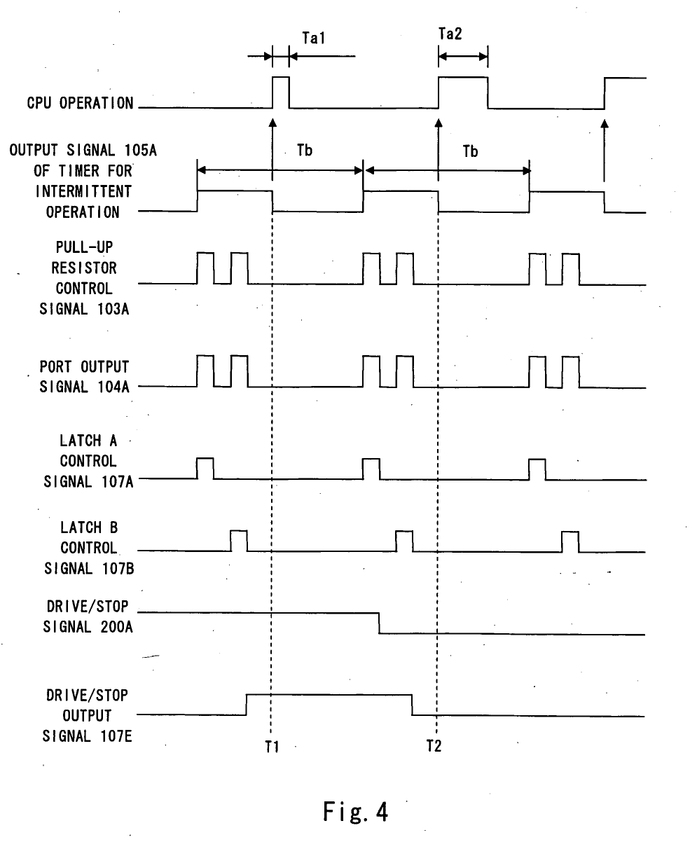

FIG. 4 is a time chart to describe the operation of the tire pressure monitor control device of this invention. The timing chart of FIG. 4 shows a CPU operation, an output signal of a timer for intermittent operation 105A, a pull-up resistor control signal 103A, a port output signal 104A, a latch A control signal 107A, a latch B control signal 107B, a drive/stop signal 200A, and a drive/stop determination signal 107E.

Referring to FIGS. 1 to 4, the timer for intermittent operation 105 counts and generates a plurality of control signals according to a reference signal from the low-frequency oscillator 106. The timer for intermittent operation 105 outputs the Tb period output signal 105A of a timer for intermittent operation to the CPU 101. The CPU 101 is activated at falling edges of the output signal 105A of a timer for intermittent operation.

The timer 105 for intermittent operation outputs a pull-up resistor control signal 103A to the motion sensor input circuit 104 at the same period Tb as the output signal 105A of a timer for intermittent operation. Further, the motion sensor input circuit 104 outputs a port output signal 107C to the latch 107 while the pull-up resistor control signal 103A is High level.

Then, the latch A control signal 107A and the latch B control signal 107B are sequentially input to the latch 107 according to the control of the latch controller 102. The latch A 107a and the latch B 107b take in, at respective different timings, the port output signal 107C generated from the drive/stop signal 200A indicating drive or stop state according to the signal from the motion sensor 200 when the latch A control signal 107A and the latch B control signal 107B are High, respectively. The drive/stop signal 200A indicates drive state by Low level and stop state by High level. When each of the latch A control signal 107A and the latch B control signal 107B changes from High to Low, the latch A 107a and the latch B 107b shown in FIG. 2 fixes and retains, at respective timings, the port output signal 107C, respectively.

After that, the output signal 105A of a timer for intermittent operation changes from High to Low, resulting in the CPU 101 which is activated to the normal operation state (High). The CPU 101 powers the pressure sensor 300 on and outputs a signal for controlling the pressure sensor 300 to measure the tire pressure. In accordance with the instruction from the CPU 101, the pressure sensor 300 provides the measured value to the differential amplifier 108. The A/D converter 109 converts the amplified analog signal to digital signal and the memory 111 stores the digital tire pressure data.

A CPU-SW information reading signal 107D which is generated when the CPU 101 in the power save mode is activated is input to the inverter 107d of the latch 107. In accordance with the input timing of the CPU-SW information reading signal 107D, the latch 107 outputs to the CPU 101 a drive/stop determination signal 107E, which is a result of logical ADD operation of the outputs of latch A 107a and latch B 107b.

Then, the CPU 101 determines whether the vehicle is driving or stopping from the drive/stop determination signal 107E and outputs the measurement result of the pressure sensor 300 to the RF transmitter 400 in accordance with the detection result of the motion sensor 200.

For example, at T1 in FIG. 4, the drive/stop determination signal 107E is High and indicating stop state. Thus, the CPU 101 goes into a power save mode (Low) without outputting the measurement result of tire pressure data from the pressure sensor 300 which is stored in the memory 111 to the RF transmitter 400. As shown in FIG. 4, the operation time of the CPU 101 is Ta1 which is shorter than Ta2 described later.

On the other hand, at T2, the drive/stop determination signal 107E is Low and indicating drive state. Thus, the CPU 101 outputs the measurement result of tire pressure data from the pressure sensor 300 which is stored in the memory 111 to the RF transmitter 400. After transmitting the pressure data to the receiver placed in a dashboard or the like of a vehicle body, not shown, through the RF transmitter 400 and the antenna 400a, the CPU 101 goes into the power save mode (Low). A driver of the vehicle can thereby check the tire pressure during driving with a screen display or the like. In this case, the operation time of the CPU 101 is longer than Ta1 as shown in FIG. 4.

After that, the output signal 105A of a timer for intermittent operation is output and the above process is repeated. The TPMS in North America requires detecting the tire pressure within 10 minutes. It is therefore necessary to configure the operation compatible with this standard by a transmission time interval Tb of the output signal of a timer for intermittent operation or the like.

Since this configuration makes the motion sensor 200 perform detection before the CPU 101 starts operating, it is not necessary to detect the physical operation in the motion sensor 200 for a long time to prevent chattering or the like while the CPU 101 is operating. This reduces the operation time of the CPU 101 to lower the power consumption of the CPU 101. It is thereby possible to increase the life of a battery, not shown, used in the tire pressure monitor control device 1000. Specifically, though it takes about 5*10-3 sec to check chattering if the motion sensor 200 detects the physical operation while the CPU 101 is operating, the present invention allows the detection to be performed in about 1*10-3 sec, which is a time required for detecting the tire pressure only.

Further, since the detection result of the motion sensor 200 is retained in the latch 107 before the CPU 101 starts operating in this configuration, it is not necessary to detect the physical operation in the motion sensor 200 for a long time for chattering or the like during the operation of the CPU 101. This reduces the operation time of the CPU 101 to further lower the power consumption of the CPU 101. In the above embodiment, the CPU 101 determines the operation for the detection results of the pressure sensor 300 using the detection results of the motion sensor 200 during the next previous power save duration of the normal operation duration, allowing more precise determination of the vehicle state.

It is apparent that the present invention is not limited to the above embodiment that may be modified and changed without departing from the scope and spirit of the invention.

What is claimed is:

1. A monitoring apparatus for monitoring a monitored object comprising:
a motion sensor detecting motion of an object;
a sensor detecting state of an object; and
a controlling circuit with intermittent operation, performing an operation for a detection result of the sensor during a normal operation duration, the operation determined based on a detection result of the motion sensor detected before the normal operation duration.

2. The monitoring apparatus of claim 1, wherein the controlling circuit determines the operation for the detection result of the sensor based on a detection result of the motion sensor detected during a next previous power save duration of the normal operation duration.

3. The monitoring apparatus of claim 1, wherein the motion sensor detects motion of a vehicle tire and the sensor detects state of the vehicle tire.

4. The monitoring apparatus of claim 1, further comprising a circuit storing a detection result of the motion sensor, and wherein the controlling circuit determines the operation for the detection result of the sensor using data stored in the storing circuit.

5. The monitoring apparatus of claim 4, wherein the storing circuit stores a plurality of results at different timings and the controller determines the operation based on the stored plurality of results.

6. The monitoring apparatus of claim 4, further comprising a timer generating a first timing signal causing the storing circuit to take in the detection result of the motion sensor and a second timing signal causing the controlling circuit to start the normal operation predetermined time after the first timing signal.

7. A monitoring apparatus comprising:
a motion sensor detecting motion of a vehicle;
a sensor detecting state of a tier of the vehicle; and
a controlling circuit repeating a normal operation duration and a power save duration alternately, in a normal operation duration, performing an operation for a detection result of the sensor based on a detection result of the motion sensor detected before the normal operation duration.

8. The monitoring apparatus of claim 7, wherein the sensor detects air pressure of the tier.

9. The monitoring apparatus of claim 7, further comprising a circuit storing a detection result of the motion sensor, and wherein the controlling circuit determines the operation for the detection result of the sensor using data stored in the storing circuit.

10. The monitoring apparatus of claim 8, wherein the storing circuit stores a plurality of detection results at different timings and the controller determines the operation based on the stored plurality of results.

11. The monitoring apparatus of claim 8, further comprising a timer signaling the storing circuit to take in the detection result of the motion sensor and signaling the controlling circuit to start the normal operation predetermined time after the storing circuit.

12. The monitoring apparatus of claim 7, wherein the controlling circuit determines the operation for the detection result of the sensor based on a detection result of the motion sensor detected during a next previous power save duration of the normal operation duration.

13. In a monitoring apparatus detecting state of a monitored object, a method for handling a detected result of the monitored object comprising:
detecting motion of an object;
detecting state of an object;
storing a detection result of the motion;
activating a controlling circuit in a power save mode for an operation of a detection result of the state, the controlling circuit changing the operation for the detection result of the state based on the detection result of the motion stored before the activation; and
turning the controlling circuit into the power save mode after the operation.

14. The method of a monitoring apparatus of claim 13, wherein a plurality of detection results the motion at different timings are stored before the activation and the controlling circuit changes the operation for the detection result of the state based on the plurality of detection results.

15. The method of a monitoring apparatus of claim 13, detecting the motion during a next previous duration of power save mode to the activation.
